(19) United States
(12) Patent Application Publication
(10) Pub. No.: US 2009/0311378 A1
(43) Pub. Date: Dec. 17, 2009

(54) METHOD FOR CONTINUOUS PRODUCTION OF FERMENTED DAIRY PRODUCTS

(75) Inventors: AARON P. WILASCHIN, St. Paul, MN (US); DANIEL L. GORDON, Plymouth, MN (US); JAMES M. OLIVE, St. Paul, MN (US); MICHELLE ZACHO, Anoka, MN (US)

Correspondence Address: GENERAL MILLS, INC., P.O. BOX 1113, MINNEAPOLIS, MN, 55440, US

(73) Assignee: GENERAL MILLS, INC.

(21) Appl. No.: 12/482,145

(22) Filed: Jun. 10, 2009

Related U.S. Application Data
(60) Provisional application No. 61/061,200, filed on Jun. 13, 2008.

(51) Int. Cl. A23C 9/13; A23C 9/127

(52) U.S. Cl. 426/43

(57) ABSTRACT

The invention provides continuous methods for preparing a fermented dairy product, the methods including steps of fermenting a dairy base with agitation while measuring the viscosity change of the fermentation mixture until an initial fermented dairy base having a target viscosity is achieved. The initial fermented dairy base is then preferably further fermented to a final fermented dairy base without agitation.

### CROSS-REFERENCE TO RELATED APPLICATIONS

This application claims the benefit of U.S. Provisional Application Ser. No. 61/061,200, filed Jun. 13, 2008, entitled “METHOD FOR CONTINUOUS PRODUCTION OF FERMENTED DAIRY PRODUCTS” which application is incorporated herein by reference in its entirety.

### FIELD OF THE INVENTION

The invention relates to a method for preparing food products. More particularly, the invention relates to methods for preparing fermented dairy products via the continuous fermentation of a dairy base. The invention is particularly useful in the preparation of yogurt products.

### BACKGROUND OF THE INVENTION

Fermented dairy products, such as yogurt, typically refer to compositions produced by culturing (fermenting) one or more dairy ingredients, also sometimes referred to as a dairy base, with a bacterial culture that contains the lactic acid-producing bacteria, such as Lactobacillus bulgaricus and/or Streptococcus thermophilus. Such products are available in a wide variety of styles and formulations.

Production facilities producing such products can experience a great deal of variability with respect to production run schedules. This is due, at least in part, to the lengthy and variable fermentation times that result from standard processing procedures and formulation variability. A number of factors can affect the fermentation time variability of the production process. These include starter culture selection, bacteriophage, fermentation temperatures, formulations, total solids content of the formulation, variation of milk sources, and operator error in the addition of ingredients to the formulation. However, a major source of the operational problems encountered during production is found in the variability in fermentation times encountered during manufacture due to the wide variability in product style or flavor.

For example, commercial fermentation typically is done by a batch process in which pH is used to monitor the progress of fermentation and determine when fermentation has reached the desired end point. While this has proven to be a useful approach, it has been found that the probe(s) used to measure pH can, in some cases, become fouled thereby leading to improper pH readings. This in turn results in the fermentation process being stopped either too soon or too late because the true pH of the fermentation mixture is either too low or too high. Additionally, milk is a natural pH buffer. This can lead to inaccurate pH readings which mask the true concentration of hydrogen ions and result in an inaccurate determination of the completion of fermentation. In either case, the result is a loss of process efficiency and/or the creation of reject material.

Additionally, prior art processes are typically carried out by first providing a fermentable dairy base, pasteurizing and homogenizing the dairy base, and then fermenting the pasteurized, homogenized dairy base. The homogenized, pasteurized dairy base is then fermented in unagitated tanks in order to minimize or avoid irreversibly damaging the protein structure of the fermented dairy product.

### SUMMARY OF THE INVENTION

The present invention provides a process that overcomes the disadvantages of the use of pH to monitor the fermentation. It provides a continuous process for the fermentation of a dairy product that employs agitation during a portion of fermentation and in-situ measurement of the viscosity of a dairy base to measure and determine when the dairy base has been fermented to a desired level. In an aspect of the invention, the continuous process comprises a multi-stage fermentation in which the first stage is agitated and the second stage is non-agitated (i.e., sedentary).

Generally speaking, the invention relates to continuous fermentation of cultured dairy products. In some aspects, the invention involves creating more than one fermented dairy base, and then combining the fermented dairy bases to provide a final cultured dairy product (yogurt). One or more fermented bases can be combined in a variety of manners to provide a final, desired cultured dairy product. Optionally, one or more additional components can be combined with the fermented bases post-fermentation, such as one or more sweetener components. Post-fermentation customization of cultured dairy products can also be employed. In a preferred embodiment, the present invention relates to continuous fermentation of cultured dairy products by carrying out all fermentation as a single fermentation base stream. In a particularly preferred embodiment, the initial addition of the bacterial culture comprises a mixture of S. thermophilus and L. bulgaricus.

In one embodiment, the present invention comprises a method for producing a fermented dairy product comprising the steps of:

a) providing a continuing in-flow of a dairy base to a fermentation vessel;

b) providing an initial addition of a bacterial culture to the fermentation vessel;

c) agitating the dairy base and the bacterial culture in the vessel under conditions adequate to provide an initial fermented dairy base having a desired viscosity; and

d) measuring the viscosity of the mixture of the dairy base and the bacterial culture in-situ in the fermentation vessel to determine when a desired viscosity has been reached while continuing agitation in the fermentation vessel.

In another embodiment, the present invention comprises a method of continuous fermentation of a dairy base comprising:

a) providing an initial in-flow of a dairy base and an initial charge of a bacterial culture to a stirred fermentation vessel;

b) providing a continuing in-flow of dairy base to a stirred fermentation vessel;

c) mixing the dairy base and the bacterial culture in the fermentation vessel until a desired quantity of dairy base has been charged to the stirred fermentation vessel and to form a partially fermented dairy base;

d) removing the partially fermented dairy base from the stirred fermentation vessel at a continuous rate upon attainment of the desired quantity of dairy base;

e) measuring the viscosity of the dairy base in the stirred fermentation vessel, and

f) adjusting the residence time of the dairy base in the stirred fermentation vessel to maintain its viscosity at a target value by varying at least one of the rate of the in-flow of dairy base or the removal of the partially fermented dairy base.

In yet another embodiment, the present invention comprises a method of continuously fermenting a dairy base comprising the steps of:

a) providing a continuing in-flow of the dairy base and an initial charge of a bacterial culture to a stirred fermentation vessel;

b) mixing the dairy base and the bacterial culture in the fermentation vessel until a desired quantity of dairy base has been charged to the stirred fermentation vessel and to form a partially fermented dairy base;

c) removing the partially fermented dairy base from the stirred fermentation vessel at a continuous rate upon attainment of the desired quantity of dairy base;

d) measuring the viscosity of the dairy base in the stirred fermentation vessel;

e) adjusting the residence time of the dairy base in the stirred fermentation vessel to maintain its viscosity at a target value by varying at least one of the rate of the in-flow of dairy base or the removal of the partially fermented dairy base; and

f) transferring the partially fermented dairy base to at least one non-stirred vessel for sedentary fermentation to a final viscosity;

wherein fermentation occurs at at least two separate temperatures.

The various aspects of the inventive concepts will now be described in more detail.

### BRIEF DESCRIPTION OF THE DRAWING

FIG. 1 is a schematic process flow diagram illustrating one embodiment of a method of continuously producing a fermented dairy product according to the invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

Generally, the invention is directed to a process for preparing a cultured dairy product by continuously fermenting a dairy base. A variety of different dairy bases may be fermented in the practice of the invention.

Throughout the specification and claims all percentages used herein are in weight percentages, and are based upon the total weight of the composition, unless otherwise indicated.

To facilitate the discussion of the invention, use of the invention to provide yogurt products, will be addressed. Yogurt products are selected because the advantages of the inventive concepts can be clearly presented. However, it is understood that the compositions and methods disclosed are applicable to any fermented dairy products, such as firm yogurt, drinkable yogurt, kefir, soft cream cheeses, soft cheeses including fromage frais and quark, fermented milk, yogurt-based or fermented milk desserts, smoothies, skyr, and the like. Further, the inventive compositions and methods described herein are applicable to any yogurt compositions, for example, the various styles mentioned herein, as well as the various fat levels (including low fat, nonfat, and standard yogurt). Examples of styles of yogurt include set style, stirred style, Swiss style, aerated style, and the like.

As used herein, the term “yogurt” includes, but is not limited to, all of those food products meeting the definition as set forth in the U.S. Food and Drug Administration Code of Federal Regulations (CFR) Title 21 Section 131.200, 131.203, and 131.206.

In general, a fermented dairy product such as yogurt can be made from a fermentable dairy base and bacterial culture. In addition, a fermented dairy product may include a gel-forming hydrocolloid component and, optionally, one or more additives.

Dairy bases for making a yogurt are well known and are described in, e.g., U.S. Pat. No. 4,971,810 (Hoyda et al.); U.S. Pat. No. 5,820,903 (Fleury et al.); U.S. Pat. No. 6,235,320 (Daravingas et al.); U.S. Pat. No. 6,399,122 (Vandeweghe et al.); U.S. Pat. No. 6,740,344 (Murphy et al.); and U.S. Pub. No. 2005/0255192 (Chaudhry et al.). In general, a dairy base includes at least one fermentable dairy ingredient. A fermentable dairy ingredient can include raw milk or a combination of whole milk, skim milk, condensed milk, dry milk (for example, dry milk solids non-fat, or MSNF). However, if desired other milks can be used as a partial or whole substitute for bovine milk, such as camel, goat, sheep or equine milk. The fermentable dairy ingredient may also comprise grade A whey, cream, and/or such other milk fraction ingredients as buttermilk, whey, lactose, lactalbumins, lactoglobulins, or whey modified by partial or complete removal of lactose and/or minerals, and/or other dairy ingredients to increase the nonfat solids content, which are blended to provide the desired fat and solids content. If desired, the dairy base can include a filled milk component, such as a milk ingredient having a portion supplied by a non-milk ingredient (for example, oil or soybean milk). Preferably, the fermentable dairy ingredient comprises bovine milk.

Preferably, the fermentable dairy ingredient is composed of bovine milk.

In general, it is well-known to typically formulate a dairy base to have a desired milk solids content and a desired fat content. In exemplary embodiments, a dairy base has a milk solids content in the range of from 1 to 50 weight percent, preferably from 4 to 25 weight percent, and even more preferably about 9 weight percent based on the total weight of the dairy base.

In addition, dairy bases typically include sweeteners, flavor ingredient(s), process viscosity modifier(s), vitamin(s), nutrient(s), combinations of these, and the like. Other ingredients that may be included are gel-forming additives, stabilizers, sequestrants, etc.

Examples of suitable sweeteners include one or more nutritive carbohydrate sweetening agents. Exemplary nutritive sweetening agents include, but are not limited to, sucrose, liquid sucrose, high fructose corn syrup, dextrose, liquid dextrose, various DE corn syrups, corn syrup solids, beet or cane sugar, invert sugar (in paste or syrup form), brown sugar, refiner's syrup, molasses, fructose, fructose syrup, maltose, maltose syrup, dried maltose syrup, malt extract, dried malt extract, malt syrup, dried malt syrup, honey, maple sugar, and mixtures thereof. In some embodiments, particularly in low fat and/or low calorie variations, the dairy base can comprise a high potency non-nutritive carbohydrate sweetening agent. Exemplary high potency sweetening agents include aspartame, sucralose, acesulfame potassium, saccharin, cyclamates, thaumatin, tagatose and mixtures thereof.

In exemplary embodiments, the sweetener is typically present in an amount of from 0 to 20 weight percent, preferably 12 to 17 weight percent based on the total weight of the dairy base composition.

In exemplary embodiments, a process viscosity modifier can be present in an amount of from 0.5 to 3 weight percent, preferably 1 to 2 weight percent based on the total weight of the dairy base composition. An exemplary process viscosity modifier can be commercially obtained from National Starch (Bridgewater, N.J.) under the tradename THERMTEX®.

Gel-forming additives suitable for use in the practice of the invention include “gel-forming hydrocolloid ingredients” which, in the context of the present invention, refer to an ingredient that disperses well in water, but due to its relatively large molecular size it is not readily soluble in water and therefore the resulting physical conformation in water is colloidal. In addition, a gel-forming hydrocolloid ingredient causes a food composition to gel to a certain degree when it is present in a given gel-forming amount and the food composition is subjected to gelling conditions. Typical gelling conditions include subjecting a dairy composition according to the present invention to a temperature in the range of from 35 to 70° F. (about 2 to about 21° C.), preferably from 35 to 55° F. (about 2 to about 13° C.), and even more preferably from 35 to 45° F. (about 2 to about 7° C.) for a time period of 0 to 12 hours. Most of the gelation will occur within 12 hours, but maximum gel set could occur after 48 hours.

In contrast to a gel-forming hydrocolloid ingredient, some hydrocolloid ingredients can be used as rheology modifiers in the processing of dairy compositions such as yogurt but such hydrocolloid ingredients may not cause such a composition to gel when exposed to gelling conditions.

In general, gel-forming hydrocolloids are well known. A gel-forming hydrocolloid ingredient is typically a polysaccharide or protein. Preferred gel-forming ingredient(s) include non-dairy, gel-forming hydrocolloid ingredient(s).

As used herein, a non-dairy, gel-forming hydrocolloid ingredient is a gel-forming hydrocolloid ingredient that is distinguishable from a dairy, gel-forming hydrocolloid. As used herein, a dairy, gel-forming hydrocolloid ingredient refers to some materials naturally found in milk that can cause a dairy composition to gel under proper conditions. For example, milk can include casein protein and/or whey protein. Such proteins can contribute to a slight gel formation of a dairy composition when exposed to proper conditions such as pH, ion concentration, temperature, combinations of these, and the like. For example, acid produced during fermentation can cause casein protein micelle dissociation and aggregation. During heating, whey protein can be denatured, becoming insoluble and tending to cause gelation. Heat denatured whey proteins can also interact with κ-caseins for further gelation in some dairy products. Such milk proteins can be classified as dairy gel-forming hydrocolloids.

An exemplary non-dairy, gel-forming hydrocolloid ingredient for use in the present invention can include gelatin, agar, alginate, carrageenan, pectin, starch, xanthan/locust bean gum blend, gellan gum, konjac gum, combinations of these, and the like. It is noted that some gel-forming hydrocolloid ingredients (e.g., starch) can have structural modifications that can influence the gel-forming ability of other hydrocolloids.

Examples of useful stabilizers and thickeners such as starch, gelatin, pectin, agar, carageenan, gellan gum, carboxy methyl cellulose (CMC), sodium alginate, hydroxy propyl, methyl cellulose, and mixtures thereof. In some embodiments, the dairy base can comprise a bovine, porcine, or piscine gelatin. A bovine gelatin in the range of about 200 to about 250 bloom strength can be used; also, Type B bovine gelatin in the range of about 220 to about 230 bloom strength is suitable.

When included, the stabilizers or thickeners can be included in an amount sufficient to provide a desired viscosity to the dairy base, such that the dairy base can be processed (e.g., pumped) through equipment during formulation of the inventive compositions. When measured at 20° C. (68° F.), the dairy base containing stabilizer and/or thickener has a viscosity in the range of about 1 to about 1000 centipoise (cP), preferably in the range of about 10 to about 1000 cP, based upon total weight of the dairy base.

The dairy base can also include calcium sequestrant in amounts sufficient to reduce the occurrence of premature precipitation of the protein content in the dairy base. By premature protein precipitation is meant any protein coagulation during the heating (e.g., pasteurization) or cooling steps. It is desirable that thickening of the dairy product occurs after the heat treatment such as during the fermentation step.

Exemplary soluble calcium sequestrants include, but are not limited to, sodium or potassium citrates (for example, trisodium citrate), phosphates, acetates, tartrates, malates, fumarates, adipates, ascorbates, and mixtures thereof. Good results are obtained when the sequestrant(s) is present at about 0.025% to about 0.15%.

Any bacterial culture useful in making fermented dairy products for consumption can be used with the dairy base composition. Such bacterial culture(s) are live and active and are well known. An exemplary bacterial culture can include any microorganism suitable for lactic fermentation such as Lactobacillus sp., Streptococcus sp., combinations of these, and the like. More specifically, a bacterial culture can include Lactobacillus delbrueckii subspecies bulgaricus, Streptococcus thermophilus, Lactobacillus lactis, Lactobacillus casei, Lactobacillus acidophilus, Bifidobacterium lactis, Bifodobacterium bifidus, Lactococcus cremoris, Lactococcus lactis, Lactococcus lactis ss diacetyllactis, combinations of these, and the like.

A variety of synonyms exist for the term “bacterial culture.” These synonyms include, for example, live culture, active culture, live and active culture, starter culture, and the like.

In a representative embodiment, the process of the invention comprises a multi-step process that includes both a stirred step and a non-stirred or sedentary step. The stirred step comprises mixing a dairy base and a bacterial culture in a suitable vessel under conditions and for a time suitable to ferment the dairy base to a desired initial level without materially damaging the protein structure of the fermenting/fermented dairy base. Upon attainment the desired fermentation level, the contents of the stirred vessel are transferred to a non-stirred vessel where fermentation is completed.

At start up, the process employs an induction phase. In one embodiment of the induction phase, an initial predetermined quantity of the dairy base and an initial charge of bacterial culture is added to the stirred fermentation vessel. Preferably the initial charge of dairy base is added as quickly as possible to the fermentation vessel. The dairy base and bacterial culture are then mixed until fermentation reaches a desired target as indicated by the attainment of a target viscosity. The time to reach this point is referred to as the initial residence time. The initial residence time may vary from product to product and will depend upon such things as the formulation of the dairy base, the operating weight of the charge to the stirred vessel, and the degree of fermentation desired in the final product. Typical residence times may vary from 30 minutes to 2 hours. Shorter or longer initial residence times may be employed as appropriate. No additional charges of dairy base are made to the fermentation vessel until the target viscosity is reached.

In another embodiment of the induction phase, an initial addition of bacterial culture is made to the stirred fermentation vessel. Subsequently, dairy base is charged to the vessel and mixed with the bacterial culture. In this embodiment the dairy base is preferably added at a slower rate than in the previously described induction phase. Typically, this rate of addition is designed to fill the stirred fermentation vessel for the duration of the initial residence time. Additionally, this inlet rate remains constant throughout the remainder of the process. When the desired quantity of dairy base has been added, an outlet pump is started and the at least partially fermented product is transferred to one or more non-stirred fermentation vessels.

As the stirred fermentation vessel fills in this embodiment, the viscosity of the dairy base increases due to the action of the bacterial culture. Although, the dairy base may not initially achieve the target viscosity before being withdrawn from the fermentation vessel, it has surprisingly been found that this phase self adjusts over time to achieve target viscosity. It has also surprisingly been found that this embodiment achieves the target viscosity more quickly than the previously described embodiment.

Once the induction phase has been completed, a continuous stirred fermentation phase commences. During this phase, a continuous in-flow of unfermented dairy base is provided to the fermentation vessel, and a continuous out-flow of at least partially fermented dairy base is commenced.

During this phase, the viscosity of the dairy base may drift away from the desired target. This may be caused by one or more factors such as uneven mixing of the fermentation composition, fluctuations in heating of the composition, the buffering capacity of milk proteins, operator error, etc. The viscosity may be returned to its desired target by altering the residence time in the fermentation vessel. For example, if the viscosity is below the desired target the operating weight in the vessel can be increased to extend the residence time. If the viscosity is above the desired target the operating weight in the vessel can be decreased to shorten the residence time.

In the present invention, the residence time may be extended by reducing the rate at which material is continuously removed from the vessel. Conversely, the residence time may be shortened by increasing the rate at which material is continuously removed from the vessel. After either adjustment has been made, the rate at which material is removed from the fermentation vessel is preferably returned to match the inlet rate. This practice establishes a new residence time based on a new volume in the fermentation vessel.

In a preferred embodiment of the present invention, the initial charge of the bacterial culture is the only charge of a bacterial culture to the fermentation vessel. Advantageously, in this embodiment the addition of dairy base is added and fermented dairy base is removed from the vessel in a manner so that the bacterial culture in the vessel self-propagates, thereby avoiding the need to additionally charge the fermentation vessel with bacterial cultures. Optionally, additional charges of bacterial cultures may be added for various reasons during the fermentation process.

During both initial fermentation (i.e., stirred fermentation) and final fermentation (i.e., sedentary fermentation) the progress of the viscosity of the fermentation composition is monitored in-situ. In a preferred embodiment, the measurement of the viscosity is carried out by use of an in-line viscometer. The measurement of the viscosity may be continuous, periodic or intermittent. While any inline viscometer may be used in the practice of the invention, one that measures resistance to vibration is preferred over one that measures resistance to rotation. Alternatively, viscosity can be measured by periodic or intermittent sampling of the fermentation composition and measurement by use of an off-line viscometer.

Fermentation, both stirred and unstirred, may also be carried out by using a multi-temperature process that employs a different fermentation temperature in each step. This is especially useful when a mixture of microorganisms are used in the bacterial culture. It has been discovered that by using this multi-temperature approach, the process can be tailored to use temperatures that are best suited for each microorganism employed. This maximizes the efficiency of the fermentation process.

Typically, this approach uses a sequential approach in which the first step preferably employs the lower or lowest fermentation temperature and each successive step employs a higher fermentation temperature. Alternatively, the multi-temperature approach may comprise simultaneous fermentation of a portion of the dairy base at each different temperature followed by blending of the fermented dairy bases in a single vessel.

Depending upon the temperature, solids content, ingredients such as sweeteners, preservatives, stabilizers, etc. and amount of culture added, the induction phase can take from about 30 to 90 minutes. Preferably, the induction phase takes from 40 to 60 minutes. Final fermentation typically takes from about three to about 14 hours. In some embodiments, fermentation is performed at a temperature in the range of about 37° C. to about 49° C. (about 100° F. to about 120° F.) for about 5 hours.

The particular, target and final fermentation end points can vary modestly. Typically, the target viscosity is in the range from about 5 to 10,000 centipoise (cP) preferably from about 10 to 1,000 cP as measured at 25° C. using a Brookfield viscometer with a No. 5 spindle for 25 seconds at 10 rpm. The pH of the product in this range is typically between 6.8 and 5.0, or more specifically usually 5.9 to 5.5, respectively. The endpoint or final viscosity of the fermented dairy base typically ranges from about 5,000 to 70,000 cP, preferably from about 10,000 to 30,000 cP measured as described above. These viscosities are generally found to relate to an end point pH range from about 5.5 to about 4.3, or specifically from about 5.2 to about 4.5. The final or end point viscosity will typically be greater than the target viscosity. The final fermented dairy base so prepared can exhibit a culture count generally greater than about 1×10⁶ colony-forming units per gram (cfu/gram) to about 1×10¹⁵ cfu/gram.

The target and final viscosity values given above are only representative of useful viscosities. One of skill in the art will appreciate that the exact viscosities will vary from product to product based upon such factors as culture selection, bacteriophage, formulations, total solids content of the formulation, style, and the like.

To reduce the secondary fermentation times, it is desirable to maintain a S. thermophilus concentration (measured in CFU/gm) to L. bulgaricus at a ratio of at least 10:1 in the continuous fermentation stage of the process, respectively. It is preferable to have S. thermophilus present at ratios of 100:1 to 10,000:1 compared to L. bulgaricus concentrations. However, depending on the duration of the fermentation, conditions of the process, slight deviations in the properties starting materials, and variation in the health and conditions of the starter culture, the bacteria strains may symbiotically strive to reach a 1:1 ratio. To maintain the desirable concentration ratio during the continuous fermentation stage, it may be necessary to: a) Introduce more S. thermophilus, directly raising their concentration; b) Add a combination of valine, leucine, histadine, glutamic acids, tryptophan, peptides containing the previous amino acids, and/or other supplements in an amount effective to enhance the growth of S. thermophilus; c) Decrease the temperature of the continuous fermentation vessel to a level effective to enhance the growth rate of S. thermophilus and/or to decrease the growth rate of L. bulgaricus; and/or d) Reduce the concentration of soluble formate, pyruvate, purine, uracil, adenosine, guanine, adenine, peptides containing the previous amino acids, and/or carbon dioxide in an amount effective to decrease the growth rate of L. bulgaricus. e) Change the concentration of dissolved gases with redox potential, like carbon oxides, nitrogen oxides and/or molecular oxygen, with the intent to alter the metabolism of L. bulgaricus and/or S. thermophilus to achieve the desired ratio. f) Induce anaerobic or micro-aerobic conditions in the yogurt base that activate alternative metabolic networks or change growth rates of either L. bulgaricus and/or S. thermophilus to achieve the desired ratio. g) Introduce strain specific phage or other viruses that attack L. bulgaricus. h) Include modified strains of L. bulgaricus that limit growth rates or reduce stable subpopulations (either automatically or induced) in a continuous fermentation. i) Include modified strains of S. thermophilus that accelerate growth rates or promote higher subpopulations (either automatically or induced) in a continuous fermentation.

After fermentation of the dairy base to the desired end point, the fermentation process is arrested, for example, by pumping the fermented dairy base through cooling heat exchangers. At this stage, the fermented dairy base is sufficiently cooled to temperatures at which the bacterial cultures are not actively fermenting the dairy base and thus do not substantially change the viscosity. Typically, the fermented dairy product can be cooled to temperatures of about 10° C. to about 20° C. or less. In some embodiments, the fermented dairy product can be cooled to temperatures of about 4° C. or less (about 40° F. or less). The temperature at which fermentation is arrested can depend upon the particular bacterial cultures selected, and can be readily determined by one of skill in the art using standard techniques.

Thus prepared, the fermented dairy base can be characterized by a viscosity of about 5,000 to about 7,000 cP, or about 10,000 cP to about 30,000 cP (at 4.4° C.). The fermented dairy base can be further characterized as having one or more of the following additional features: a pH in the range of about 4.65 to about 4.75; a viscosity in the range of about 20,000 cP to about 30,000 cP; a solids content in the range of about 5% to about 40%, or about 10% to about 20%; a percent butterfat in the range of about 0.3% to about 6%, or about 0.5% to about 5%; and a total milk solids content in the range of about 0.01% to about 50%.

Optionally, compositions prepared by the process of the invention can further include a variety of adjuvant materials to modify the nutritional, organoleptic, flavor, color, or other properties of the composition. For example, the fermented dairy product can additionally include synthetic and/or natural flavorings, and/or coloring agents can be used in the compositions of the invention. Any flavors typically included in fermented dairy products can be used in accordance with the teachings of the invention. Also, flavor materials and particulates, such as fruit and fruit extracts, nuts, chips, and the like, can be added to the fermented dairy products as desired. The flavoring agents can be used in amounts in the range of about 0.01 to about 3%. Coloring agents can be used in amounts in the range of about 0.01 to 0.2% (all percentages based upon total weight of the fermented dairy product).

Optionally, nutrients such as vitamins can be added to the dairy base. Any vitamins typically included in fermented dairy products can be included, such as vitamin A, vitamin D, vitamin E, vitamin C, folate, thiamin, riboflavin, niacin, pyrixodine, cyanocobalamine, biotin, pantothenic acid, calcium, phosphorus, iodine, iron, magnesium, zinc, manganese, and mixtures thereof. Addition of vitamins to the style composition can minimize heat degradation of the vitamins (such as Vitamin A and Vitamin C) and minimize off-flavors that can result from loss of the vitamins during pasteurization.

When included, fruit and fruit extracts (e.g., sauces or purees) can comprise about 1% to about 40%, preferably from about 5% to 15% of the fermented dairy product. The fruit component can be admixed with the emulsifier prior to addition to the first and/or second fermented dairy bases, or can be added as a separate component, as desired.

In the manufacture of Swiss-style yogurt, a fruit flavoring can be blended substantially uniformly throughout the fermented dairy product after fermentation is complete but prior to packaging. A static mixer can be used to blend the fruit component into the fermented dairy product with minimal shear.

In the manufacture of “sundae” style yogurt, fruit flavoring can be deposited at the bottom of the container, and the container can then be filled with the fermented dairy product (e.g., yogurt mixture). To prepare a sundae style yogurt product employing a stirred style yogurt, the dairy base is prepared with added thickeners and/or stabilizers to provide upon resting a yogurt texture that mimics a set style yogurt. In this variation, the fruit is added directly to the container, typically to the bottom, prior to filling with the yogurt.

The fruit flavoring can be provided as a sauce or puree and can be any of a variety of conventional fruit flavorings commonly used in fermented dairy products. Typical flavorings include strawberry, raspberry, blueberry, strawberry-banana, boysenberry, cherry-vanilla, peach, pineapple, lemon, orange, and apple. Generally, fruit flavorings include fruit preserves and fruit or fruit puree, with any of a combination of sweeteners, starch, stabilizer, natural and/or artificial flavors, colorings, preservatives, water, and citric acid or other suitable acid to control the pH. Minor amounts of calcium can be added to the fruit to control the desired texture of the fruit preparation typically provided by a soluble calcium material such as calcium chloride. Typical minor amounts can be less than 50 mg of calcium per 226 g serving.

If aspartame is added to the style composition, all or a portion of the aspartame can be pre-blended with the fruit flavoring.

Aeration

Optionally, the fermented dairy product can be admixed with a gas, when the desired product is an aerated yogurt product or fermented mousse. In one such embodiment, the fermented dairy product is admixed with nitrogen gas. The gas can be charged into the fermented dairy product in accordance with any conventional method. For example, the gas can be forced through small orifices into the fermented dairy product as the product flows through a tube or vessel into a mixing chamber, where uniform distribution occurs. Any conventional nontoxic, odorless, tasteless gas, such as air, nitrogen, nitrous oxide, carbon dioxide, and mixtures thereof can be used.

In accordance with some embodiments of the invention, the fermented dairy product can be aerated or whipped while maintained within a desired temperature range. Typically, the fermented dairy product will be aerated from a native density of about 1.1 g/cc to a density in the range of about 0.56 g/cc to about 0.9 g/cc, or in the range of about 0.7 g/cc to about 0.8 g/cc. The skilled artisan can select a commercially available aerator/mixer for use herein. One suitable aerator in accordance with the inventive concepts is a Tanis Rotoplus 250 aerator available from Tanis Food Tec in The Netherlands. The Tanis Rotoplus aerator consists of a mixing chamber fed by a positive displacement pump and air flow system. Product flow is controlled by pump speed adjustment and airflow is controlled by flow meter adjustment. Stainless steel concentric rows of intermeshing teeth on a stator and a rotor produce a uniformity and consistency in the mix. A coolant, for example glycol, can be used in a jacket surrounding the mix chamber to maintain a preferred constant temperature in the range of about 4° C. to about 30° C., or about 4° C. to about 15° C., or in the range of about 4° C. to about 7° C. during aeration.

A pressure in the range of about 15 psi to about 30 psi can be maintained in the mixer to aid in the formation of air cells. The aerated fermented dairy product can be gradually transported from those pressures to atmospheric pressure; the gradual shift in pressure reduces air cell collapse.

The ratio of fermented dairy product to gas can be in the range of about 3:1 to about 1:1, or in the range of about 2:1.

During aeration, it can be important to control temperature to allow large visible air cells to form more readily. Maintaining the temperature in the ranges identified above can be important to control the final density of the product which, in turn, can be important to fast formation of large visible air cells and to minimizing air cell collapse upon extended storage. It will be appreciated that desirable large visible air cells form at 24 to 48 hours with whipping and filling temperatures in the above-mentioned temperature ranges.

The aerated fermented dairy product (including any flavor components added) can then be transported to a holding tank, if desired, and held for a desired amount of time. In some embodiments, for example, it can be desirable to retain the aerated fermented dairy product in a holding tank for a time period in the range of about 5 to about 15 minutes,

The aerated fermented dairy product can then be packaged in a conventional manner for handling and storage purposes. The aerated fermented dairy product is charged to a conventional container for yogurt products, such as coated paper or plastic cups or tubes fabricated from flexible film packaging stock. After filling, the filled containers are applied with a lid or other closure or seal means, assembled into cases, and entered into refrigerated storage for distribution and sale. In some embodiments, air cells in the yogurt product can achieve visible size within about 24 to 48 hours after fill, such sizes in the range of about 130 to about 3,000 μm. About 24 to 48 hours after fill, the aerated dairy blend can achieve a viscosity of about 52,000 cP to about 55,000 cP.

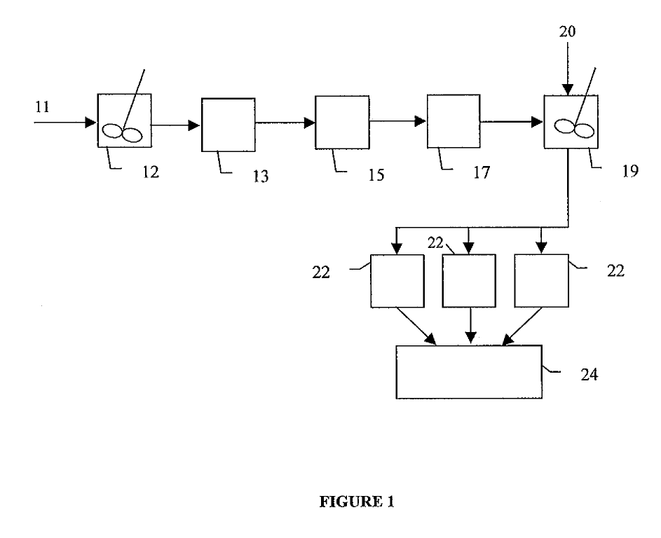

Referring to FIG. 1, a representative embodiment of the method of the invention is further illustrated. A dairy base 11 is provided to a stirred blend tank 12. The dairy base 11 comprises at least one dairy ingredient. Optional ingredients such as water, a sweetener and/or thickener, etc. can also be included in the dairy base 11.

Addition of a sweetener to the dairy base can comprise an additional sub-step of admixing liquid or granular sucrose and high fructose corn syrup prior to addition to the dairy base. The dairy base can include an amount of sweetener sufficient to provide a desired non-fat solids content and/or organoleptic properties to the dairy base.

Once the ingredients of the dairy base 11 are combined and mixed, they are typically transferred from blend tank 12 and homogenized in the homogenizer at 13. The homogenized dairy base is then pasteurized at 15 and cooled at 17 to a desired temperature. The pasteurized and homogenized dairy base is then charged to stirred fermentation vessel 19 and an initial addition of bacterial culture 20 is charged to vessel 19. The combined dairy base and culture 20 are then fermented in stirred fermentation vessel 19 under conditions suitable to ferment the dairy base to a selected target point with agitation. Once the selected target point is reached, the intermediately fermented dairy base is transferred to a non-stirred vessel 22 where final fermentation continues until a selected end point is reached. Once the end point is reached, fermentation is arrested at 24, to provide a fermented dairy base. The dairy base may then be further processed or stored as desired.

Because sedentary fermentation may take a substantially longer time than intermediate fermentation, it is preferred to use multiple final fermentation tanks to accommodate the volume of intermediately fermented dairy base and provide sufficient residence time to complete fermentation.

In some embodiments, the fermentable dairy ingredient does not require any processing, in addition to standard homogenization and/or pasteurization, prior to use in the dairy base (for example, the inventive concepts do not require pre-processing of the fermentable dairy ingredient to remove such materials as minerals, proteins, or any other like substances).

Optionally, the method of the invention can comprise removal of water from the first dairy base to allow for addition of water in a post-fermentation addition of components such as sweetener to the fermented dairy base.

The dairy base 11 is typically pasteurized by heating for times and temperatures effective to form a pasteurized or heat-treated dairy base. As is known, the dairy base can be heated to lower temperatures for extended times (for example, 190° F./88° C. for 30 minutes) or alternatively higher temperatures for shorter times (for example, 203° F./95° C. for about 38 seconds). Intermediate temperatures for intermediate times can also be employed, as known in the art. Other pasteurization techniques or, even sterilization, can be practiced (such as light pulse, ultra high temperature, ultra high pressure, and the like) if effective and economical.

The pasteurized dairy base is typically homogenized in a conventional homogenizer to disperse evenly the added materials and the fat component supplied by various ingredients. If desired, the pasteurized dairy base can be warmed prior to homogenization from typical milk storage temperatures of about 40° F. (about 5° C.) to temperatures of 150° F. to about 170° F. (about 65° C. to about 75° C.), preferably about 163° F. (about 73° C.). In some embodiments, homogenization is performed in a two-stage homogenizer, with a target pressure of about 1000 psi (about 6900 kPa) in the first stage, and a target pressure of about 500 psi (about 3450 kPa) in the second stage. In certain commercial practices, the sequence of the homogenization and pasteurization steps can be reversed.

The pasteurized and homogenized dairy base is then brought to incubation temperature, usually in the range of about 104° F. to about 115° F. (about 40° C. to about 46° C.). When heat pasteurization is employed, a cooling step after pasteurization can be used, wherein the homogenized and pasteurized dairy base blend is cooled to the desired incubation temperature. The cooled, pasteurized and homogenized dairy base can be characterized as having a viscosity in the range of about 5 to about 40,000 cP, preferably about 10 to about 5000 cP.

Aspects of the inventive concepts will now be described with reference to the following non-limiting examples.

### EXAMPLE 1

Continuous Fermentation of Yogurt Base

A typical yogurt base (900 lbs/40.9 kg) comprising water, non-fat dried milk, crystalline sugar, cream, starch, and gelatin was blended according to the weight percentages in Table 1.

TABLE 1
Formula for Typical Yogurt Base 1

| Ingredients | % (w/w) |
|---|---|
| Water | 70% |
| Non-Fat Dried Milk | 10% |
| Dry Sugar | 8% |
| Cream | 5% |
| Starch | 4% |
| Gelatin | 3% |
| Total | 100% |

### Homogenization and Pasteurization

The mixture was homogenized in two stages at 500 psi (3447.4 kilopascal) then 400 psi (2757.9 kilopascal). Next, the yogurt base was pasteurized at 93.3° C. for 20 seconds at a rate of 17.8 lbs per minute (8.1 kg/min).

### Continuous Fermentation

After the pasteurization, the yogurt base was cooled to 110° F. (43.3° C.) (AGC Engineering, Chicago, Ill., USA) and pumped into a suitable vessel for continuous fermentation (Waukesha Cherry-Burrell, Delavan, Wis., USA). The temperature in the vessel was maintained at 110° F. (43.3° C.) via heated water in a temperature jacket, the yogurt base was kept under agitation with a swept surface anchor blade whose arms reached up ⅓ of the vessel wall. The pH was measured with a inline pH probe (TopHit pH Sensor with Memosens, Endress+Houser, Reinach, Switzerland). The viscosity was measured with a mounted viscometer (Viscoliner 500, Nametre Company, Metuchen, N.J., USA). The initial pH of the yogurt base was 6.5, and the dynamic viscosity was approximately 19 cP.

When ten percent (90 lbs (40.9 kg)) of the yogurt base had been charged to the fermentation vessel, 10 grams of a freeze dried yogurt bacterial culture containing Streptococcus thermophilus, and Lactobacillus bulgaricus at a ratio of 1:1 was added to the vessel. Then the remaining ninety percent of the desired weight was added to the fermentation vessel. The increase in viscosity, indicating the drop in pH, were monitored with inline probes and recorded the fermentation of lactose to lactic acid and the subsequent thickening of the base. When the desired operating weight of 900 lbs (409 kg) was reached, the blending, homogenization and pasteurization steps were stopped.

Variation 1

After the combined yogurt base and bacterial culture reached the desired initial dynamic viscosity of 35 cP, corresponding to a pH of 5.7, the blending, homogenization and pasteurization unit operations were resumed and the stream of homogenized and pasteurized yogurt base was again supplied to the fermentation vessel at the flow rate of 17.8 lb/min (8.1 kg/min). An outlet pump was used to drain the vessel at a rate needed to maintain the desired initial viscosity. The startup residence time for yogurt base was 50 minutes. After the initial residence time, the dynamic viscosity of the yogurt base increased to 38 cP.

During the course of the continuous fermentation, the dynamic viscosity gradually drifted away from the desired target, due to uneven mixing, fluctuations in heating or other environmental factors. To return the dynamic viscosity to the desired level, the operating weight was changed (the weight was increased 15% for a longer residence time if the dynamic viscosity decreased and lowered by 15% for a shorter residence time if the dynamic viscosity increased too quickly). The ratio of S. thermophilus to L. bulgaris remained constant during this time at 10:1.

Samples were taken from the vessel outlet stream throughout the course of this first set of experiments to finish the fermentation. Ten minutes of the outlet stream were collected and fermented in a tank held at 110° F. (43.3° C.), without an agitation, until the yogurt base reached a desired viscosity of 15,000 cP. Then the yogurt base was passed through a shear valve and cooled quickly to 40° F. 5 (4.4° C.) (AGC Engineering, Chicago, Ill., USA). The final ratio of S. thermophilus to L. bulgaris remained at 10:1.

Variation 2

Similar to above except that the desired initial dynamic viscosity was 45 cP. This, corresponds to a pH of 5.3. The blending, homogenization, and pasteurization rate was kept at 17.8 lbs per minute (8.1 kg/min), but the desired weight was 800 lbs (363 kg). Therefore the residence was set at 45.5 minutes. The ratio of S. thermophilus to L. bulgaris remained constant at the lower pH at 10:1. The dynamic viscosity after a residence time turnover was 49 cP. The sedimentary and finishing conditions were maintained the same.

### EXAMPLE 2

Determining the Robustness of Continuous Fermentation

A typical yogurt base comprising of water, non-fat dried milk, crystalline sugar, cream, starch, and gelatin was blended according the weight percentages in Table 2. The mixture was homogenized and pasteurized under standard practices as described in Example 1.

TABLE 2
Formula for Typical Yogurt Base 2

| Ingredients | % (w/w) |
|---|---|
| Water | 70% |
| Non-Fat Dried Milk | 12% |
| Dry Sugar | 6% |
| Cream | 7% |
| Starch | 4% |
| Gelatin | 1% |
| Total | 100% |

### Continuous Fermentation

After pasteurization, the base was cooled to 40° F. (4.4° C.) and stored in a chilled reservoir. The mixture was pumped out of the reservoir and heated to 110° F. (43.3° C.) with a crossflow heat exchanger at rate of 23.4 lbs per minute into a suitable vessel for continuous fermentation. The temperature in the vessel was maintained at 110° F. (43.3° C.) via heated water in a temperature jacket. The yogurt base was kept under agitation with a swept surface anchor blade whose arms reached up ⅓ of the vessel wall. The initial dynamic viscosity was 16 cP.

When the vessel was filled to the final operating weight 1000 lbs (454.5 kg), the pasteurization and homogenization operations were put into standby mode. Five grams of freeze dried bacterial culture containing Streptococcus thermophilus, and Lactobacillus bulgaricus was added to the vessel, traditionally provided at a ratio of 1:1. The increase in viscosity was measured with inline probes and recorded the fermentation of lactose to lactic acid and subsequent thickening of the base.

The desired dynamic viscosity was 50 cP. When the fermentation reached these targets, the heat exchanger and pump we started and maintained at a rate of 23.4 lbs per minute (10.6 kg/min) throughout the duration of the experiment. The outlet pump was started at the same rate giving a residence time of 42.7 minutes. After the first residence time the viscosity built to a dynamic viscosity of 48.6 cP. The ratio of S. thermophilus to L. bulgaris was measured at 10:1.

During the first five and half hours the dynamic viscosity remained relatively constant, with nominal oscillations of ±5% (46 to 51 cP). It increased over the next two hours by 20% to 58 cP. To reduce the dynamic viscosity, the outlet pump speed was increased to decrease residence time therefore lowering the operating volume to 934 lbs (424.5 kg). This returned the conditions in the vessel to the desired viscosity. Throughout the viscosity changes, the ratio of S. thermophilus to L. bulgaris was remained close to 10:1.

After ten hours of run time, the viscosity began to drop by 17% to a value of 40.3 cP. It was desired to raise the operating weight to 978 lbs (444.5 kg). This was done by slowing down the outlet pump. The new residence time was 41.8 minutes. This was maintained without further need to change the operating weight.

Samples were taken from the vessel outlet stream throughout the course of this first set of experiments to finish the fermentation. Ten minutes of the outlet stream were collected and fermented in a tank held at 110° F. (43.3° C.), without an agitation, until the yogurt base reached a viscosity of 11,000 cP. Then the yogurt base was passed through a shear valve and cooled quickly to 40° F. (4.4° C.). The final ratio of S. thermophilus to L. bulgaris was measured at 10:1.

### EXAMPLE 3

Fermentation Guided by Viscosity and Exploring Two Different Temperatures in the Sedentary Stage

A generic highfat yogurt base comprising of water, non-fat dried milk, cream, and starch was blended according the weight percentages in Table 3. The mixture was homogenized and pasteurized under standard practices as described in example 1.

TABLE 3
Formula for Generic Yogurt Base 3

| Ingredients | % (w/w) |
|---|---|
| Water | 87% |
| Non-Fat Dried Milk | 9% |
| Cream | 3% |
| Starch | 1% |
| Total | 100% |

After pasteurization, the base was cooled to 40° F. (4.4° C.) and stored in a chilled reservoir. The mixture was pumped out of the reservoir and heated to 110° F. (43.3° C.) with a crossflow heat exchanger at rate of 23.4 lbs per minute (10.6 kg/min) into a suitable vessel for continuous fermentation. The temperature in the vessel was maintained at 110° F. (43.3° C.) via heated water in a temperature jacket. The yogurt base was kept under agitation with a pitched blade (20″ (50 cm) A310 Impeller with 1.5″ (3.75 cm) bore, Lightnin, Rochester, N.Y., USA) mounted two inches from the bottom of the tank. The initial pH of the yogurt base was 6.6, and the dynamic viscosity was approximately 20 cP.

When the yogurt base reached 10% (150 lbs/68.1 kg) of the desired operating weight a 5% (previously prepared bacterial culture (7.5 lbs/3.4 kg)) containing Streptococcus thermophilus, and Lactobacillus bulgaricus was added to the vessel at a ratio of 10:1. The remaining 85% (1275 lbs (58 kg)) of the operating weight was added after the addition of the bacterial culture. The increase in viscosity was measured with inline probes and recorded the fermentation of lactose to lactic acid and the subsequent thickening of the base. When the desired operating weight of 1500 lbs (682 kg) was reached, the blending, homogenization and pasteurization unit operations were put into standby mode.

For this formula, the desired operating conditions for continuous fermentation was an initial dynamic viscosity of 61.3 cP. When the fermentation reached this target, the heat exchanger and pump were started and maintained at a rate of 23.4 lbs per minute (10.6 kg/min) throughout the duration of the experiment. The outlet pump was started at the same rate giving a residence time of 64 minutes. After the first residence time the viscosity remained at 61 cP. The ratio of S. thermophilus to L. bulgaris was measured at 100:1.

Variation 1

Three minutes of outlet flow, 70.2 lbs (32 kg), were collected and cooled in an ice bath to 105° F. (40.6° C.) and kept in an unagitated vessel to finish the fermentation. The temperature of the vessel was maintained at 105° F. (40.6° C.). The viscosity was sampled with an offline meter to track the remaining viscosity build to a final value of 15,000 cP. Then the yogurt base was passed through a shear valve and cooled quickly to 40° F. (4.4° C.). The final ratio of S. thermophilus to L. bulgaris was measured at 10:1.

Variation 2

Three minutes of outlet flow, 70.2 lbs (32 kg), were collected and heated to 115° F. (46.1° C.) then kept in an unagitated vessel to finish the fermentation. The temperature of the vessel was maintained at 115° F. (46.1° C.). The viscosity was sampled with an offline meter to track the remaining viscosity build to a final value of 15,000 cP. Then the yogurt base was passed through a shear valve and cooled quickly to 40° F. (4.4° C.). The final ratio of S. thermophilus to L. bulgaris was measured at 100:1.

### EXAMPLE 4

A generic lowfat yogurt base comprising of water, non-fat dried milk, and starch was blended according the weight percentages in Table 4. The mixture was homogenized and pasteurized under standard practices as described in Example 1. After pasteurization, the base was cooled to 40° F. and stored in a chilled reservoir.

TABLE 4
Formula for Generic Yogurt Base 4

| Ingredients | % (w/w) |
|---|---|
| Water | 87% |
| Non-Fat Dried Milk | 12% |
| Starch | 1% |
| Total | 100% |

Variation 1

Continuous Fermentation

The mixture was pumped out of the reservoir and heated to 115° F. (46.1° C.) with a crossflow heat exchanger at rate of 27.5 lbs per minute (12.5 kg/min) into a suitable vessel for continuous fermentation. The temperature in the vessel was maintained at 115° F. (46.1° C.) via heated water in a temperature jacket, the yogurt base was kept under agitation with a pitched blade mounted two inches from the bottom of the tank. The initial pH of the yogurt base was 6.6, and the dynamic viscosity was approximately 13 cP.

When the yogurt base reached ten percent of the desired operating weight, (110 lbs (50 kg)) a previously prepared starter culture was added (5% or 55 lbs (25 kg)) containing Streptococcus thermophilus, and Lactobacillus bulgaricus was added to the vessel at a ratio of 10:1. The remaining eighty five percent of the operating weight (935 lbs (42.5 kg)) was added after the addition of the starter culture. The increase in viscosity was measured with an inline probe and recorded the fermentation of lactose to lactic acid and the subsequent thickening of the base. When the desired operating weight of 1100 lbs (500 kg) was reached, the blending, homogenization and pasteurization unit operations were put into standby mode.

For this formula, the desired operating conditions for continuous fermentation was a dynamic viscosity of 45.7 cP at 115° F. (46.1° C.). When the fermentation reached these targets, the beat exchanger and pump were started and maintained at a rate of 27.5 lbs per minute 12.5 kg/min) throughout the duration of the experiment. The outlet pump was started at the same rate giving a residence time of 40 minutes. After the first residence time the viscosity raised to 50 cP. The ratio of S. thermophilus to L. bulgaris was measured at 100:1.

Four minutes of outlet flow, 110 lbs (50 kg), were collected and cooled in an ice bath to 105° F. and kept in an unagitated vessel to finish the fermentation. The temperature of the vessel was maintained at 105° F. (40.6° C.). The viscosity build was sampled with an offline meter to track the increase until the yogurt reached the desired viscosity of 13,000 cP. Then the yogurt base was passed through a shear valve and cooled quickly to 40° F. (4.4° C.). The ratio during fermentation of S. thermophilus to L. bulgaris was measured at 10:1.

Variation 2

The mixture was pumped out of the reservoir and heated to 105° F. with a crossflow heat exchanger at rate of 27.5 lbs per minute 12.5 kg/min) into a suitable vessel for continuous fermentation. The temperature in the vessel was maintained at 105° F. (40.6° C.) via heated water in a temperature jacket, the yogurt base was kept under agitation with a pitched blade mounted two inched from the bottom of the tank. The initial dynamic viscosity of the yogurt base was approximately 13 cP. This corresponds to an initial pH of 6.6.

When the yogurt base reached one tenth of the desired operating weight, (110 lbs (50 kg)) a previously prepared bacterial culture containing Streptococcus thermophilus, and Lactobacillus bulgaricus was added to the vessel. The remaining ninety percent of the operating weight was added after the addition of the bacterial culture. The increase in viscosity was measured with inline probes and recorded the fermentation of lactose to lactic acid and the subsequent thickening of the base. When the desired operating weight of 1100 lbs (500 kg) was reached, the blending, homogenization and pasteurization unit operations were put into standby mode.

For this formula, the desired operating conditions for continuous fermentation was a dynamic viscosity of 50 cP at 105° F. (40.6° C.). When the fermentation reached these targets, the heat exchanger and pump were started and maintained at a rate of 27.5 lbs per minute (12.5 kg/min) throughout the duration of the experiment. The outlet pump was started at the same rate giving a residence time of 45 minutes. After the first residence time the viscosity raised to 56.2 cP. The ratio of S. thermophilus to L. bulgaris was measured at 10:1.

Four minutes of outlet flow, 110 lbs (50 kg), were collected and heated to 115° F. (46.1° C.) and kept in an unagitated vessel to finish the fermentation. The temperature of the vessel was maintained at 115° F. (46.1° C.). The viscosity build was sampled with an offline meter to track the increase until the yogurt reached the desired viscosity of 13,000 cP. Then the yogurt base was passed through a shear valve and cooled quickly to 40° F. (4.4° C.). The ratio during fermentation of S. thermophilus to L. bulgaris was measured at 100:1.

1. A method for producing a fermented dairy product comprising the steps of:
a) providing a continuing in-flow of a dairy base to a fermentation vessel;
b) providing an initial addition of a bacterial culture to the fermentation vessel;
c) agitating the dairy base and the bacterial culture in the vessel under conditions adequate to provide an initial fermented dairy base having a desired viscosity; and,
d) measuring the viscosity of the mixture of the dairy base and the bacterial culture in-situ in the fermentation vessel to determine when the desired viscosity has been reached while continuing agitation in the fermentation vessel.

2. The method of claim 1, comprising the further step of:
e) adjusting the residence time of the mixture of the dairy base and the bacterial culture in the fermentation vessel by continuously withdrawing the initial fermented dairy base from the fermentation vessel at a rate adequate to provide and maintain the desired viscosity.

3. The method according to claim 2, wherein the continuous, steady state in-flow of the dairy base and the bacterial culture to the vessel and the rate at which the initial fermented dairy base is continuously withdrawn from the vessel are different.

4. The method according to claim 3, wherein the continuous, steady state in-flow is greater than the continuous rate at which the initial fermented dairy base is withdrawn from the vessel.

5. The method according to claim 3, wherein the continuous, steady state in-flow is less than the continuous rate at which the initial fermented dairy base is withdrawn from the vessel.

6. The method of claim 2, comprising the further steps of:
f) continuously transferring the initial fermented dairy base to a non-agitated fermentation vessel for a time adequate to provide a final fermented dairy base having a final viscosity; and
g) continuously withdrawing final fermented dairy base from the non-agitated fermentation vessel.

7. The method according to claim 6, wherein the fermented dairy base is cooled to a temperature adequate to arrest fermentation.

8. The method according to claim 6, wherein the dairy base is fermented step (b) and step (e) at a temperature of from about 115° C. to about 105° C.

9. The method of claim 6, comprising the further step of storing the fermented dairy base.

10. The method according to claim 2, wherein the dairy base is homogenized.

11. The method according to claim 10, wherein the dairy base is pasteurized.

12. The method according to claim 2, wherein fermentation step (a) further comprises:
i) adjusting the temperature of the dairy base to a temperature suitable for fermentation and charging a portion of the dairy base to the fermentation vessel;
ii) charging the bacterial culture to the fermentation vessel and mixing with the dairy base; and
iii) charging the remainder of the dairy base to the fermentation vessel with mixing.

13. A method of continuously fermenting a dairy base comprising:
a) providing an initial in-flow of a dairy base and an initial charge of a bacterial culture to a stirred fermentation vessel;
b) providing a continuing in-flow of dairy base to a stirred fermentation vessel;
c) mixing the dairy base and the bacterial culture in the fermentation vessel until a desired quantity of dairy base has been charged to the stirred fermentation vessel and to form a partially fermented dairy base;
d) removing the partially fermented dairy base from the stirred fermentation vessel at a continuous rate upon attainment of the desired quantity of dairy base;
e) measuring the viscosity of the dairy base in the stirred fermentation vessel; and
f) adjusting the residence time of the dairy base in the stirred fermentation vessel to maintain its viscosity at a target value by varying at least one of the rate of the in-flow of dairy base or the removal of the partially fermented dairy base.

14. A method of continuously fermenting a dairy base comprising the steps of:
a) providing a continuing in-flow of the dairy base and an initial charge of an bacterial culture to a stirred fermentation vessel;
b) mixing the dairy base and the bacterial culture in the fermentation vessel until a desired quantity of dairy base has been charged to the stirred fermentation vessel and to form a partially fermented dairy base;
c) removing the partially fermented dairy base from the stirred fermentation vessel at a continuous rate upon attainment of the desired quantity of dairy base;
d) measuring the viscosity of the dairy base in the stirred fermentation vessel;
e) adjusting the residence time of the dairy base in the stirred fermentation vessel to maintain its viscosity at a target value by varying at least one of the rate of the in-flow of dairy base or the removal of the partially fermented dairy base; and
f) transferring the partially fermented dairy base to at least one non-stirred vessel for sedentary fermentation to a final viscosity;
wherein fermentation occurs at at least two temperatures.

15. The method according to claim 1, wherein the measurement of the viscosity is carried out by use of an in-line viscometer.

16. The method according to claim 1, wherein the initial addition of the bacterial culture comprises a mixture of S. thermophilus and L. bulgaricus.

17. The method according to claim 1, wherein the bacterial culture comprises a mixture of S. thermophilus and L. bulgaricus, and the ratio of S. thermophilus concentration to L. bulgaricus concentration in the continuous fermentation stage of the process is at least about 10:1.

18. The method according to claim 17 wherein the ratio of S. thermophilus concentration to L. bulgaricus concentration in the continuous fermentation stage of the process is at a ratio of from about 100:1 to about 10,000:1.

19. The method according to claim 17 wherein the ratio of S. thermophilus concentration to L. bulgaricus concentration in the continuous fermentation stage of the process is adjusted by one or more of the steps selected from the group consisting of:
a) introducing S. thermophilus to the fermentation vessel;
b) adding one or more of valine, leucine, histadine, glutamic acids, tryptophan, peptides containing the previous amino acids, and/or other supplements in an amount effective to enhance the growth rate of S. thermophilus;
c) decreasing the temperature of the continuous fermentation vessel to a level effective to enhance the growth rate of S. thermophilus and to decrease the growth rate of L. bulgaricus;
d) reducing the concentration of one or more of soluble formate, pyruvate, purine, uracil, adenosine, guanine, adenine, peptides containing the previous amino acids, and/or carbon dioxide in an amount effective to decrease the growth rate of L. bulgaricus;
e) changing the concentration of dissolved gases with redox potential to alter the metabolism of L. bulgaricus and/or S. thermophilus;
f) inducing anaerobic or micro-aerobic conditions in the yogurt base that activate alternative metabolic networks or change growth rates of either L. bulgaricus and/or S. thermophilus;
g) introducing strain specific phage or other viruses that attack L. bulgaricus;
h) including modified strains of L. bulgaricus that limit growth rates or reduce stable subpopulations in a continuous fermentation; and
i) including modified strains of S. thermophilus that accelerate growth rates or promote higher subpopulations in a continuous fermentation.
